(19) United States
(12) Patent Application Publication
(10) Pub. No.: US 2011/0175453 A1
(43) Pub. Date: Jul. 21, 2011

(54) METER SOCKET TRANSFER SWITCH

(75) Inventors: Brandon M. Batzler, Hartford, WI (US); Kenny J. Stair, North Prairie, WI (US); Sie T. Lim, Jefferson, WI (US)

(73) Assignee: Briggs & Stratton Corporation

(21) Appl. No.: 12/688,703

(22) Filed: Jan. 15, 2010

(51) Int. Cl. H02J 9/04

(52) U.S. Cl. 307/68

(57) ABSTRACT

A control system for a home electrical system includes a first switch installed at a meter socket of a utility module for controlling flow of electricity from a utility source to an electrical load, a second switch installed in a home generator for controlling flow of electricity from the generator to the electrical load, and circuitry configured to actuate the first and second switches. The circuitry includes at least one interlock to provide power to the electrical load from only one of the utility source and the generator at any given time.

### BACKGROUND

The present disclosure relates generally to the field of building electrical systems and more specifically to building electrical systems including utility power sources and standby power sources. Standby power systems are generally configured to provide backup power to electrical loads in the event of a utility power failure. Transferring between the utility source and the generator can be facilitated by an automatic transfer switch.

### SUMMARY

One exemplary embodiment of the invention relates to a control system for a home electrical system. The control system includes a first switch installed at a meter socket for controlling flow of electricity from a utility source to an electrical load, a second switch installed in a home generator for controlling flow of electricity from the generator to the electrical load, and circuitry configured to actuate the first and second switches. The circuitry includes at least one interlock configured to provide power to the electrical load from only one of the utility source and the generator at any given time.

Another exemplary embodiment of the invention relates to a method for controlling a home electrical system. The method includes actuating a first switch installed at a meter socket of a utility module for controlling flow of electricity from a utility source to an electrical load, actuating a second switch installed in a home generator for controlling flow of electricity from the generator to the electrical load, and interlocking the first switch and the second switch to provide power to the electrical load from only one of the utility source and the generator at any given time.

Another exemplary embodiment of the invention relates to a home electrical system. The home electrical system includes a circuit breaker panel coupled to a number of electrical loads, a utility module coupled to the circuit breaker panel, a power line coupled to the utility module and configured to provide electricity from a utility provider, an engine-generator-set coupled to the utility module, and a control system. The control system includes a first switch installed at a meter socket of the utility module for controlling flow of electricity from the utility provider to the circuit breaker panel, a second switch installed in the engine-generator-set for controlling flow of electricity from the engine-generator-set to the circuit breaker panel, and circuitry configured to actuate the first and second switches. The circuitry includes at least one interlock configured to provide power to the circuit breaker panel from only one of the utility provider and the engine-generator-set at any given time.

Alternative exemplary embodiments relate to other features and combinations of features as may be generally recited in the claims.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a schematic diagram illustrating a building electrical system, according to an exemplary embodiment.

FIG. 2 is an exploded view of an electric meter and switch for a building electrical system, according to an exemplary embodiment.

FIG. 3 is a schematic view of a building electrical system, according to an exemplary embodiment.

FIG. 4 is a flow chart illustrating a software interlock for the system of FIG. 1, according to an exemplary embodiment.

FIG. 5 is an electrical diagram illustrating an electrical interlock for the system of FIG. 1, according to an exemplary embodiment.

FIGS. 6-11 are schematic diagrams illustrating locations of switches for utility and generator power, according to various exemplary embodiments.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

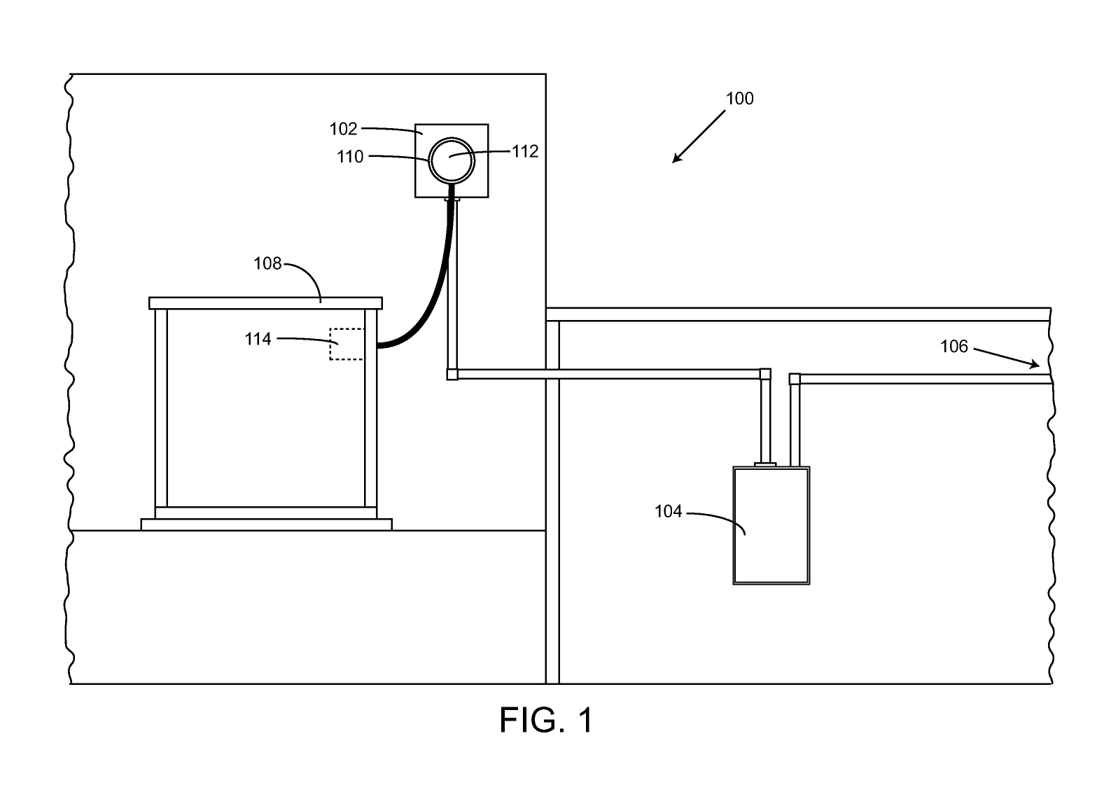

FIG. 1 illustrates an electrical system 100 for a building (e.g., a home electrical system) according to an exemplary embodiment. Electrical system 100 includes an electric utility module 102 electrically coupled to an off-site utility power source (not shown) and configured to provide power from the off-site utility source to a distribution or breaker panel 104. Distribution panel 104 (e.g., a circuit breaker box, a fuse box, etc.) is configured to route electrical power to electrical loads 106 (not specifically shown in FIG. 1) in the building. Electrical system 100 also includes a generator 108 (e.g. a home standby generator) for providing electrical power to distribution panel 104 instead of or in addition to the utility power provided at module 102. For example, generator 108 may be configured to provide power to distribution panel 104 in the event of a utility power failure. According to various exemplary embodiments, generator 108 may be a home standby generator, a portable generator, or any generator capable of providing power to a distribution panel of a building.

Utility module 102 is further configured to receive a switch 110 (e.g., an electronic switch) that is plugged into or electrically coupled to a meter socket of module 102 and is configured to receive an electric meter 112. Generator 108 includes a switch 114 (e.g., an electronic switch) that is configured to communicate with switch 110 to form a transfer switch configured to automatically switch power to distribution panel 104 between utility power and generator power. For example, in the event of a utility power failure, switches 110 and 114 may automatically sense the loss of power and route power from generator 108 to distribution panel 104 instead of from the utility source at module 102. Switches 110 and 114 may be controlled by at least one interlock system to prevent both of switches 110 and 114 from being closed at the same time (i.e., allowing current to flow from the utility source and generator 108 at the same time). According to various exemplary embodiments, switches 110 and 114 may includes relay contacts, MOSFETs, IGBTs, or any other electronically selectable switch.

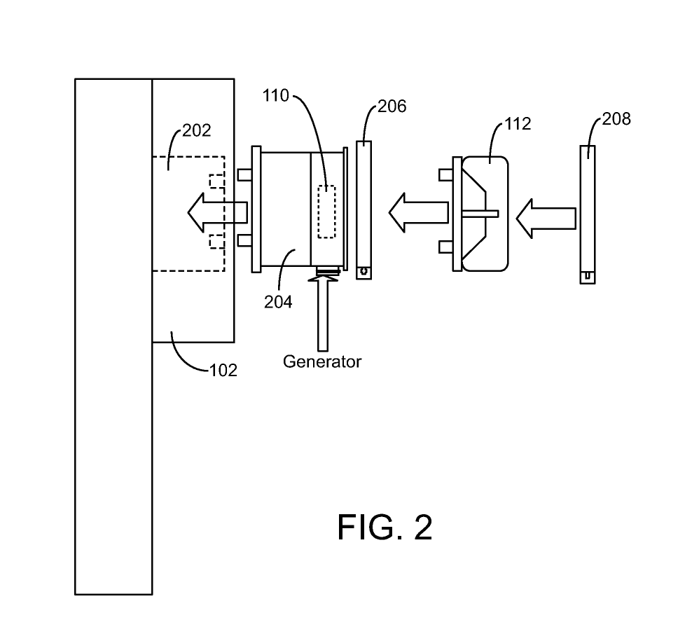

Referring to FIG. 2, the coupling of module 102, switch 110, and meter 112 is illustrated in greater detail, according to one exemplary embodiment. Module 102 includes a receptacle or meter socket 202 configured to mechanically and electrically receive a housing 204 including switch 110. Housing 204 may be secured into place using a collar 206. Housing 204 is configured to mechanically and electrically receive meter 112, which may be secured into place using a collar 208. According to various exemplary embodiments, housing 204 may be any mechanical structure configured to house switch 110 and couple to a meter socket of a utility module. According to various exemplary embodiments, utility meter 112 may be any meter for tracking electricity usage of a home and configured to couple to a meter socket of a utility module. Installation of switch 110 may be greatly simplified as compared to conventional automatic transfer switches and may have reduced installation time. This may result in reduced up-front end user (e.g., homeowner) system cost due to lower overall system and installation costs because labor is significantly reduced.

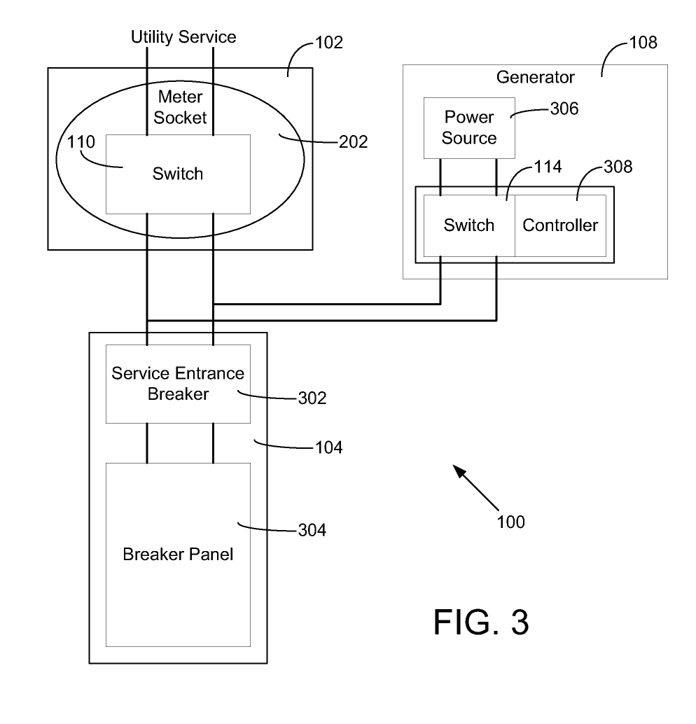

Referring to FIG. 3, electrical system 100 is illustrated using a schematic view, according to an exemplary embodiment. Generator 108 and utility service are configured for electrical coupling to distribution panel 104. Distribution panel 104 may include a service entrance breaker 302 and a breaker panel 304, however according to other exemplary embodiments, breaker 302 and panel 304 may be integral. Switches 110 and 114 are controlled by at least one interlock to control the flow of electricity to panel 104 so that current does not flow from a power source 306 in generator 108 at the same time as current from the utility service.

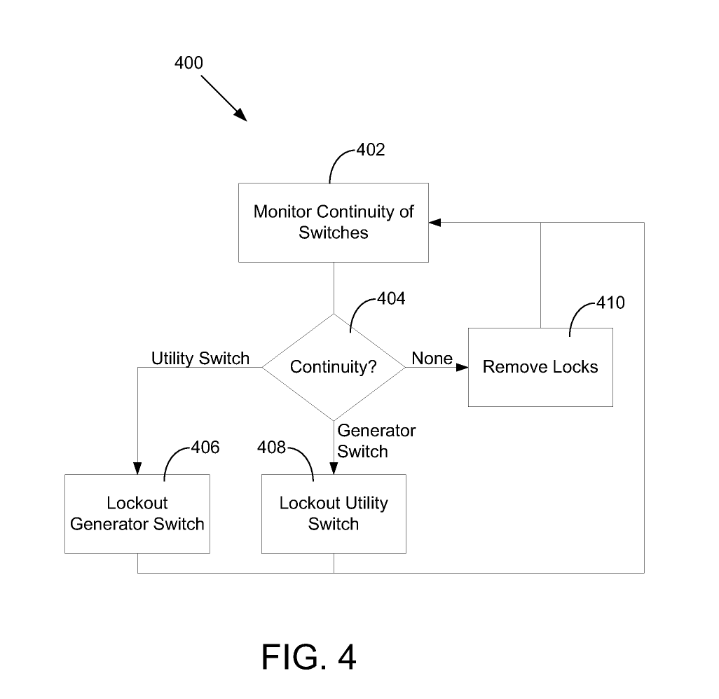

In order to control the flow of electricity, in the embodiment of FIG. 3, generator 108 includes a controller 308 configured to provide a software interlock for switches 110 and 114. Controller 308 may monitor continuity across switches 110 and 114. If continuity is detected on either of switch 110 or switch 114, controller 308 may lock out the other switch. This process is described in more detail with reference to FIG. 4. According to various exemplary embodiments, controller 308 may be a microcontroller configured to process operations for a software interlock, a hardwired controller, or any other digital or analog circuitry configured to provide a software interlock for electrical system 100.

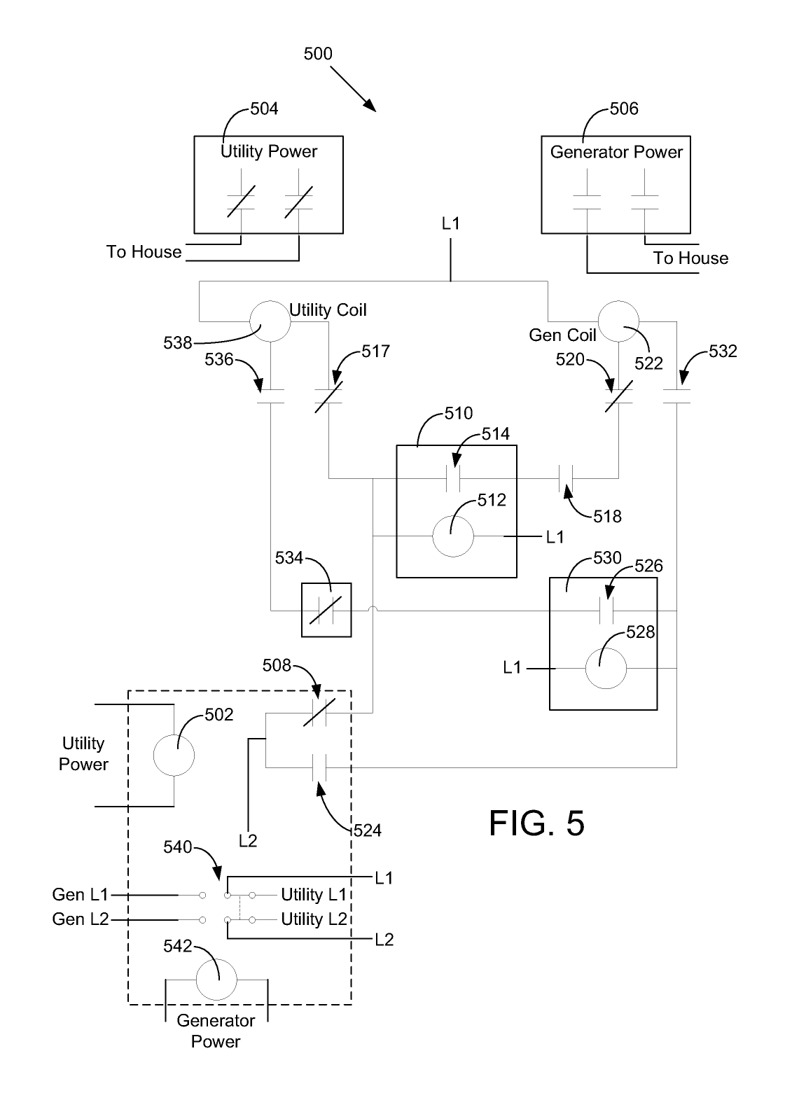

In addition to or instead of the software interlock (e.g., shown in FIG. 4), electrical system 100 may include an electronically selectable mechanical interlock to prevent current from being provided to panel 104 from generator 108 and the utility source at the same time. The mechanical interlock may include micro-switches configured to lockout switch 110 or switch 114 before the other switch can open. This process is described in more detail with reference to FIG. 5.

Referring to FIG. 4, a software interlock process or method 400 of electrical system 100 is illustrated, according to an exemplary embodiment. Referring to the elements of the electrical system 100 shown in FIG. 3, controller 308 monitors the continuity of switches 110 and 114 (step 402). If continuity is found at the utility switch (switch 110) between the utility source and panel 104 (step 404), then controller 308 locks out the generator switch (switch 114) and prevents it from closing. Controller 308 then continues to monitor for continuity. If continuity is found at the generator switch (switch 114) between generator 108 and panel 104 (step 404), then controller 308 locks out the utility switch (switch 110) and prevents it from closing (step 408). Controller 308 then continues to monitor for continuity. If controller 308 does not find any continuity (step 404), then it removes any existing locks on the utility switch or generator switch (step 410). Controller 308 then continues to monitor for continuity.

Referring to FIG. 5, an electrical diagram illustrates a mechanical interlock 500 for electrical system 100 according to an exemplary embodiment. In the illustrated exemplary embodiment, interlock 500 generally includes various relay coils and contacts for interlocking the utility and generator sources. The generator power may be provided at one of two separate inputs, L1 and L2, of equal power. When utility power is present, a utility control relay coil 502 (e.g., located in module 102) is energized, meter socket contacts 504 for the utility power are in a closed position, generator source contacts 506 are open, and utility power is available to panel 104 of the building. Interlock 500 is specifically illustrated at a default or zero energy state where no power is being provided from the generator or utility sources. In this default state, the electrically closed contacts are shown with a slash through them.

When utility power fails or is otherwise unavailable and generator 108 powers on to provide generator power, utility power control coil 502 is de-energized. Current from generator 108 may then flow from L2 through a closed contact 508 to energize a delay timer 510. Delay timer 510 includes a timer 512 configured to delay the closing of a contact 514 by a predefined time period. This delay allows a utility coil 516 to energize via a closed contact 517 and open contacts 504 for utility power. With utility coil 516 energized, a utility micro-switch 518 coupled to delay timer 510 changes state to close and allow current from L2 to pass through a contact 520 and a generator coil 522. Generator coil 522 is then energized, thus closing generator source contacts 506 and allowing current to flow from generator 108 to panel 104.

When utility power is restored, control relay 502 is energized, opening contact 508 and closing a contact 524. Current then flows from L2 and through contact 524 to energize a delay timer 526. Delay timer 526 includes a timer 528 configured to delay the closing of a contact 530 by a predefined time period. During the delay, current travels through a contact 532 to energize generator coil 522 to open generator source contacts 506 and remove generator power from panel 104. After the preset delay of delay timer 526, contact 530 and a generator micro-switch 534 closes and current from L2 flows to through closed contact 536 to power utility coil 516. Energizing utility coil 516 closes utility source contacts 504 providing utility power back to panel 104. The cycle described above may then repeat itself.

Further referring to FIG. 5, in some exemplary embodiments, an additional switch 540 and generator power control coil 542 may be used to ensure that interlock 500 always switches back to utility power as a default, for example in the event of a generator fault. Switch 540 is biased so that power to the L1 and L2 lines is always provided by utility L1 and utility L2 lines unless generator control coil 542 is energized. If generator control coil 542 is energized, indicating that generator 108 is operating (e.g., due to a utility power failure), switch 540 closes a circuit connecting lines L1 and L2 to the generator L1 and generator L2 power lines. Actuation of switch 540 is controlled by generator coil 542.

While a specific electrical configuration is illustrated according to one exemplary embodiment, it is noted that according to other exemplary embodiments, other electrical configurations may be used that are capable of providing an interlock between the utility and generator power sources. It is also noted that according to various exemplary embodiments, the circuitry illustrated in FIG. 5 may be integrated at a single location or may be distributed across multiple locations, for example, with some circuitry located in generator 108 and some located in utility module 102.

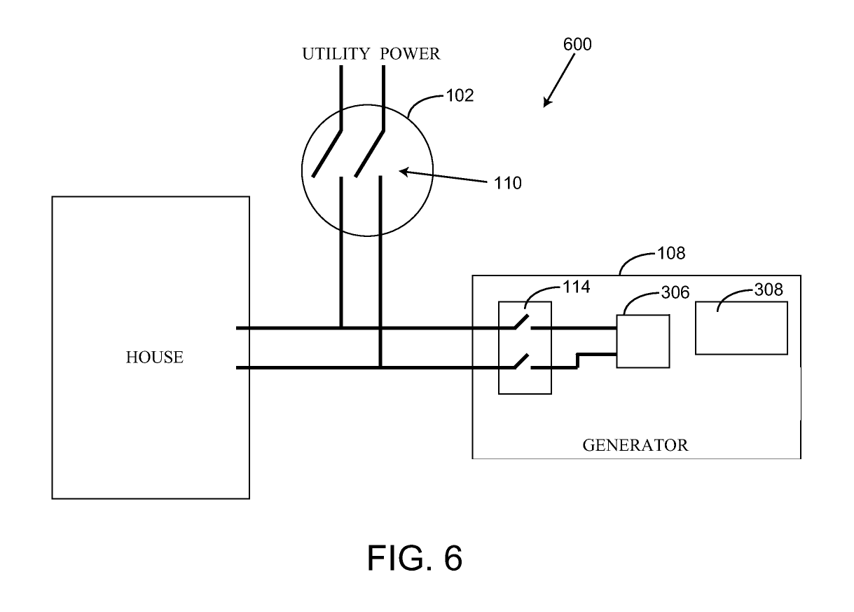

While switches 110 and 114 are shown in specific locations in FIGS. 1-3, according to other exemplary embodiments, switches 110 and 114 may be placed at various other locations, for example as illustrates in FIGS. 6-11. The various locations may allow for less home intrusion during installation, for no separate transfer switch enclosure, and for lessening the installation time. Each location option may be controlled using a power management system, for example, controller 308, because the options switch whole house power to generator 108 during standby operation. While the location of controller 308 (e.g., an intelligent control board) is illustrated in specific locations in FIGS. 1-3, according to other exemplary embodiments, controller 308 may be placed at various other locations, for example as illustrated in FIGS. 6-11. It is noted that the schematic wiring diagrams of FIGS. 6-11 are not to scale and are for visual representation only. Further, neutral and ground terminations are not shown in the diagrams.

Referring to FIG. 6, an electrical system 600 includes an automatic transfer switch that may be hardwired, according to an exemplary embodiment. Switch 110 is located in utility module 102 (e.g., in a meter collar and electrically coupled into meter socket 202) while switch 114 is located in generator 108 and coupled to power source 306. Generator 108 may also include a circuit breaker electrically coupled between switch 114 and power source 306. Controller 308 is shown located in generator 108, but could also be located in utility module 102. If switch 110 is closed, then switch 114 is open and utility power is provided to the house. If switch 114 is closed, then switch 110 is open and generator power is provided to the house. The configuration of electrical system 600 may allow for a more simple and cost effective installation. Further, the configuration shown in FIG. 6 is intended to reduce the amount of control and sensing wiring.

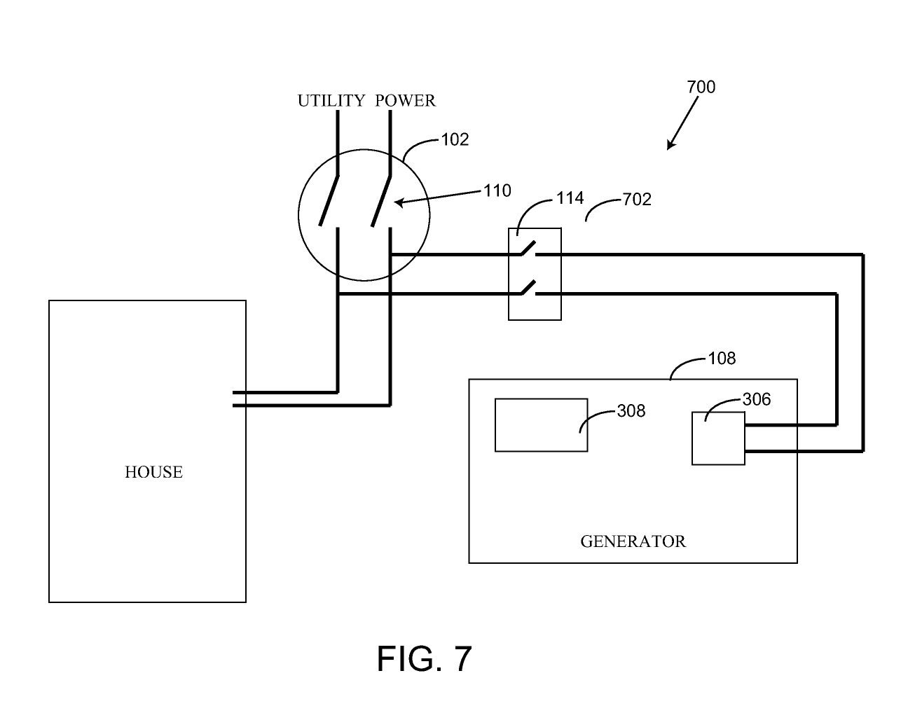

Referring to FIG. 7, an electrical system 700 includes an automatic transfer switch that may be hardwired, according to another exemplary embodiment. Switch 110 is located in utility module 102 while switch 114 is located in a box 702 (e.g., an electrical box) near utility module 102 and is coupled to power source 306 of generator 108. Box 702 may be any apparatus (e.g., mounted on the house) that is capable of housing switch 114 and may or may not include other electrical or mechanical elements. Controller 308 is shown located in generator 108, but could also be located in utility module 102 or in box 702. The configuration of electrical system 700 is intended to reduce the need for modification to an existing generator 108 and may provide for increased utility meter serviceability.

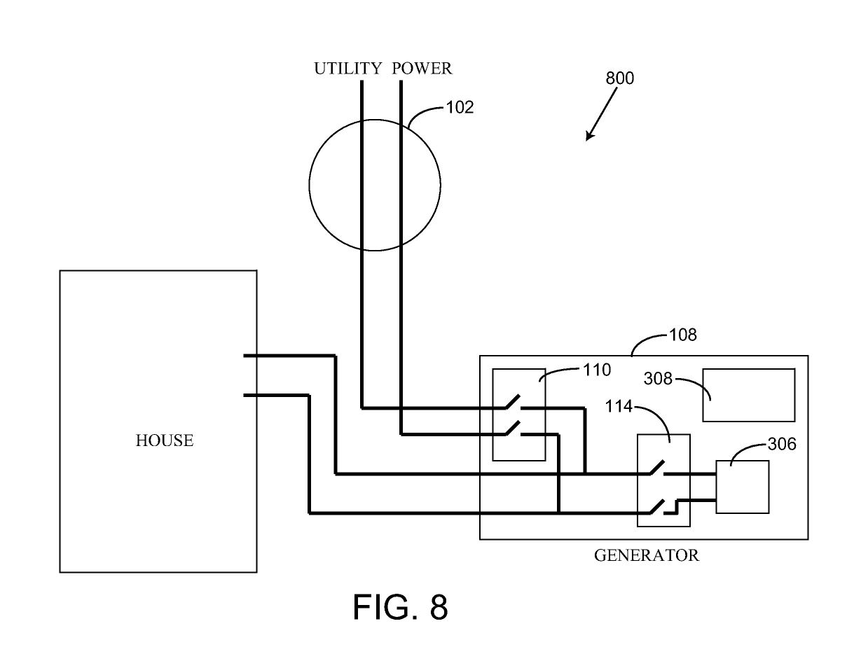

Referring to FIG. 8, an electrical system 800 includes an automatic transfer switch that may be hardwired, according to another exemplary embodiment. Switches 110 and 114 are both located in generator 108. Switch 110 is electrically coupled to utility module 102 while switch 114 is coupled to power source 306. Controller 308 is located in generator 108. The configuration of electrical system 800 is intended to allow for installation without involvement of the utility company. Further, the configuration provides for a single transfer switch package, for a single primary installation location, and for efficient installation.

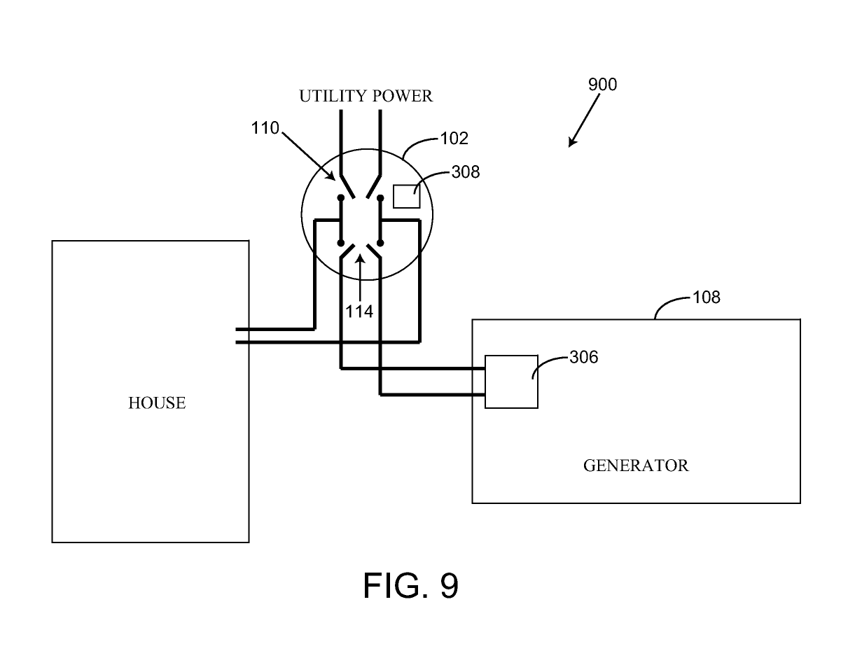

Referring to FIG. 9, an electrical system 900 includes an automatic transfer switch that may be hardwired, according to another exemplary embodiment. Switches 110 and 114 are both located in utility module 102. Switch 110 is electrically coupled to the utility power source while switch 114 is coupled to power source 306. Controller 308 is also located in utility module 102. The configuration of electrical system 900 is intended to allow for efficient system installation.

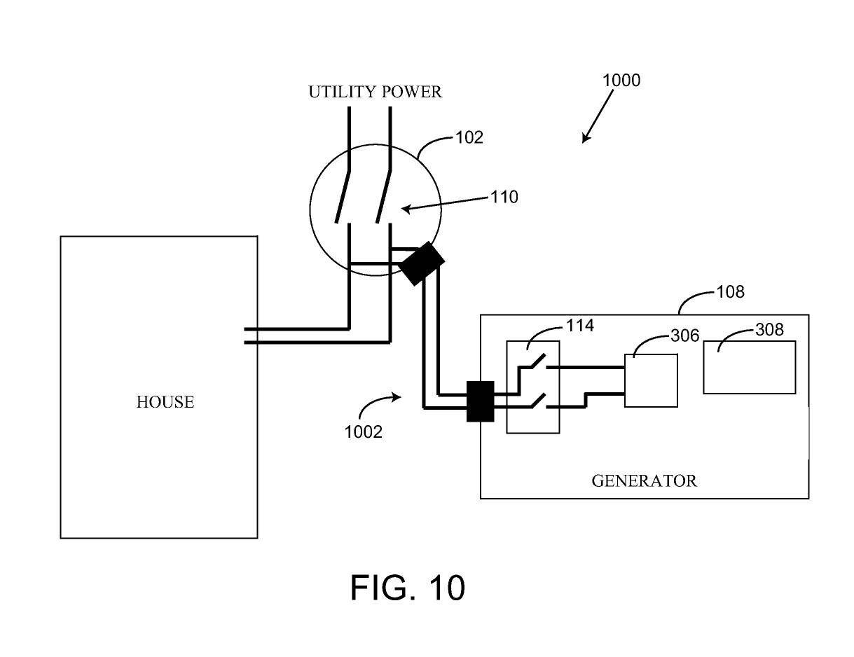

Referring to FIG. 10, an electrical system 1000 includes an automatic transfer switch that may be installed using a cord connection 1002, for example an electrical whip, according to another exemplary embodiment. Switch 110 is located in utility module 102 while switch 114 is located in generator 108 and coupled to power source 306. Controller 308 is shown located in generator 108, but could also be located in utility module 102. The configuration of electrical system 1000 is intended to allow for efficient system installation if generator 108 is in close proximity to utility module 102.

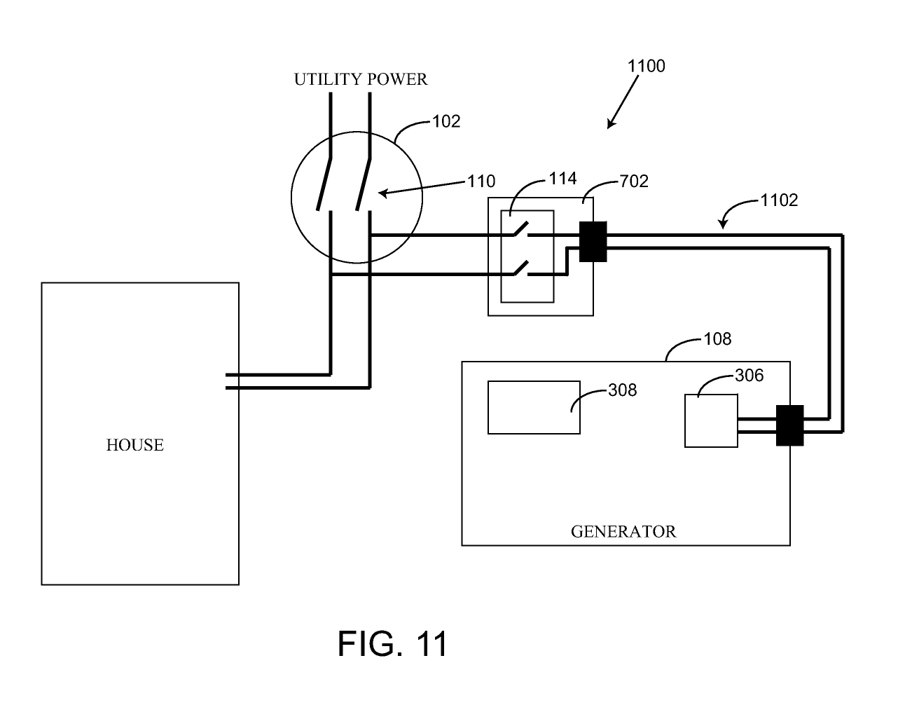

Referring to FIG. 11, an electrical system 1100 includes an automatic transfer switch that may be installed using a cord connection 1102, for example an electrical whip, according to another exemplary embodiment. Switch 110 is located in utility module 102 while switch 114 is located in box 702 near utility module 102 and is coupled to power source 306 of generator 108. Controller 308 is shown located in generator 108, but could also be located in utility module 102 or in box 702. The configuration of electrical system 1100 is intended to allow for efficient system installation if generator 108 is in close proximity to utility module 102 and may provide for increased utility meter serviceability.

While the exemplary embodiments illustrated in the figures and described herein are presently preferred, it should be understood that these embodiments are offered by way of example only. Accordingly, the present application is not limited to a particular embodiment, but extends to various modifications. The order or sequence of any processes or method steps may be varied or re-sequenced according to alternative embodiments.

According to various exemplary embodiments, method 400 and/or controller 308 may be embodied as software, computer program products, or machine instructions on any machine-readable media. Alternatively, method 400 and/or controller 308 may be implemented using computer processors or logic controllers capable of performing the functions described above or may be implemented as a hardwired system.

It is important to note that the construction and arrangement of the control system and electricity system shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter. For example, the position of elements may be reversed or otherwise varied, and the nature or number of discrete elements or positions may be altered or varied. Accordingly, all such modifications are intended to be included within the scope of the present application. The order or sequence of any process or method steps may be varied or re-sequenced according to alternative embodiments. Other substitutions, modifications, changes and omissions may be made in the design, operating conditions and arrangement of the exemplary embodiments without departing from the scope of the present application.

As noted above, embodiments within the scope of the present application include software, computer program products, or machine instructions comprising machine-readable media for carrying or having machine-executable instructions or data structures stored thereon. Such machine-readable media can be any available media which can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

It should be noted that although the figures herein may show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the application. Likewise, software implementations could be accomplished with standard programming techniques with rule based logic and other logic to accomplish the various connection steps, processing steps, comparison steps and decision steps.

What is claimed is:

1. A control system for a home electrical system, comprising:
a first switch installed at a meter socket for controlling flow of electricity from a utility source to an electrical load;
a second switch installed in a home generator for controlling flow of electricity from the generator to the electrical load; and
circuitry configured to actuate the first and second switches, the circuitry comprising at least one interlock configured to provide power to the electrical load from only one of the utility source and the generator at any given time.

2. The control system of claim 1, wherein the circuitry comprises micro-switches configured to lockout one of the first and second switches before the other of the first and second switches opens.

3. The control system of claim 1, wherein the circuitry comprises a controller configured to monitor the first and second switches for continuity, the controller locking out one of the first and second switches if continuity is detected on the other of the first and second switches.

4. The control system of claim 3, wherein the circuitry further comprises micro-switches configured to lockout one of the first and second switches before the other of the first and second switches opens.

5. The control system of claim 1, wherein the home generator is a home standby generator.

6. The control system of claim 1, wherein the first and second switches comprise electronic switches.

7. The control system of claim 1, wherein the electrical load comprises a home distribution panel configured to provide power to multiple electrical loads within the home.

8. The control system of claim 1, further comprising a housing enclosing the first switch, one portion of the housing being coupled to the meter socket and another portion of the housing being coupled to an electrical meter.

9. A method for controlling a home electrical system, comprising:
actuating a first switch installed at a meter socket of a utility module for controlling flow of electricity from a utility source to an electrical load;
actuating a second switch installed in a home generator for controlling flow of electricity from the generator to the electrical load; and
interlocking the first switch and the second switch to provide power to the electrical load from only one of the utility source and the generator at any given time.

10. The method of claim 9, wherein the interlocking comprises locking out one of the first and second switches using micro-switches before the other of the first and second switches opens.

11. The method of claim 9, wherein the interlocking comprises monitoring the first and second switches for continuity and locking out one of the first and second switches if continuity is detected on the other of the first and second switches.

12. The method of claim 11, wherein the interlocking further comprises locking out one of the first and second switches using micro-switches before the other of the first and second switches opens.

13. The method of claim 9, wherein the home generator comprises a home standby generator.

14. The method of claim 9, wherein the first and second switches comprise electronic switches.

15. The method of claim 9, wherein the electrical load comprises a home distribution panel configured to provide power to multiple electrical loads within the home.

16. The method of claim 9, wherein the first switch is mounted in a housing, one portion of the housing being coupled to the meter socket and another portion of the housing being coupled to an electrical meter.

17. A home electrical system, comprising:
a circuit breaker panel coupled to a number of electrical loads;
a utility module coupled to the circuit breaker panel;
a power line coupled to the utility module and configured to provide electricity from a utility provider;
an engine-generator-set coupled to the utility module; and
a control system comprising:
a first switch installed at a meter socket of the utility module for controlling flow of electricity from the utility provider to the circuit breaker panel;
a second switch installed in the engine-generator-set for controlling flow of electricity from the engine-generator-set to the circuit breaker panel; and
circuitry configured to actuate the first and second switches, the circuitry comprising at least one interlock configured to provide power to the circuit breaker panel from only one of the utility provider and the engine-generator-set at any given time.

18. The control system of claim 17, wherein the circuitry comprises micro-switches configured to lockout one of the first and second switches before the other of the first and second switches opens.

19. The control system of claim 17, wherein the circuitry comprises a controller configured to monitor the first and second switches for continuity, the controller locking out one of the first and second switches if continuity is detected on the other of the first and second switches.

20. The control system of claim 19, wherein the circuitry further comprises micro-switches configured to lockout one of the first and second switches before the other of the first and second switches opens.
